(19) United States
(12) Patent Application Publication
(10) Pub. No.: US 2006/0210836 A1
(43) Pub. Date: Sep. 21, 2006

(54) Magnetic recording medium and magnetic storage unit

(75) Inventor: Takashi Gouke, Higashine (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/152,118

(22) Filed: Jun. 14, 2005

(30) Foreign Application Priority Data
Mar. 15, 2005 (JP) 2005-073983

(51) Int. Cl. G11B 5/66

(52) U.S. Cl. 428/829

(57) ABSTRACT

A magnetic recording medium is disclosed that includes a substrate, a base layer provided on the substrate, and a recording layer provided on the base layer. The recording layer includes a first magnetic layer and a second magnetic layer from the base layer side. Each of the first magnetic layer and the second magnetic layer includes a ferromagnetic material composed mainly of CoCrPtB. The first magnetic layer contains more B and less Cr than the second magnetic layer on an atomic percentage basis.

### BACKGROUND OF THE INVENTION

1. Field of the Invention

The present invention relates generally to magnetic recording media and magnetic storage units, and more particularly to a magnetic recording medium with a recording layer having multiple magnetic layers and a magnetic storage unit including the same.

2. Description of the Related Art

In recent years, magnetic storage units, for instance, magnetic disk units, have been used for a wide variety of purposes as storage units for digitized video and music. In particular, the magnetic disk unit has been used for home video recording, and with its characteristics of high-speed access, small size, and large capacity, has been taking the place of the conventional home video apparatus, so that its market scale has increased remarkably. Video has a large amount of information in particular, which requires the magnetic disk unit to be increased in capacity. Therefore, for a further increase in recording density, which has increased at an annual rate of 100%, it is necessary to develop technologies for magnetic recording media and magnetic heads for recording with higher densities.

In order to improve recording density, efforts have been made to increase the coercive force of the recording layer of the magnetic recording medium and reduce the product tBr of remanent magnetic flux density Br and film thickness t. Such efforts have been made in order to oppose a demagnetizing field, which increases as a magnetization unit corresponding to one bit becomes extremely small because of an increase in recording density. That is, a decrease in magnetization due to the demagnetizing field is prevented by increasing the coercive force, and the strength of the demagnetizing field is reduced by increasing the product tBr.

On the other hand, conventionally, a quaternary alloy system or a quinary alloy system formed by adding an element (or elements) to a CoCrPt alloy is employed as the ferromagnetic material of the recording layer of the magnetic recording medium. In particular, a CoCrPtB alloy has been employed as a ferromagnetic material generating low medium noise and having an excellent S/N ratio. Further, a magnetic recording medium having a recording layer formed of two layers each of a CoCrPtB alloy is disclosed in, for instance, Japanese Laid-Open Patent Application No. 2003-196822.

However, in order to further increase the recording density of the recording medium, it is desired to increase the coercive force of the recording layer, reduce the product tBr of remanent magnetic flux density Br and film thickness t, and further reduce medium noise. However, a mere reduction in the film thickness t of the recording layer reduces the coercive force, and increases medium noise to cause the problem of degradation of S/N ratio.

In studying decreases in the film thickness of the recording layer and increases in the coercive force of the recording layer, the inventor of the present invention has found that an excessive reduction in the film thickness of the recording layer decreases the anisotropic magnetic field and the saturation magnetization of the recording layer. The anisotropic magnetic field refers to magnetic field strength required to reverse magnetization by applying a magnetic field in the direction opposite to the magnetization direction when the magnetization direction is parallel to the direction of a magnetocrystalline easy axis. The anisotropic magnetic field and the coercive force are closely related, and the coercive force decreases when the anisotropic magnetic field decreases.

FIG. 1 is a graph showing the relationship between the magnetic characteristics and the thickness of the recording layer of a magnetic recording medium. The vertical axis in FIG. 1 indicates the saturation magnetization (indicated by circles) and the anisotropic magnetic field (indicated by triangles) of the recording layer. The horizontal axis in FIG. 1 indicates the thickness of the recording layer. The characteristics indicated in FIG. 1 were obtained from magnetic recording media that were equally configured except that the recording layer differed in thickness. Further, the magnetic recording media were substantially equal in configuration to that of the comparative example of a first embodiment described below except that a single-layer CoCrPtBCu film was employed as the recording layer.

FIG. 1 shows that the values of saturation magnetization and anisotropic magnetic field are substantially constant when the recording layer has great thickness, that is, when the recording layer is 20 nm and 28 nm in thickness. However, it was found that as the recording layer is reduced in thickness, the saturation magnetization gradually decreases and the anisotropic magnetic field decreases sharply at or below a thickness of 13 nm. It is considered that the saturation magnetization and the anisotropic magnetic field thus decrease because a layer formed in the beginning of the formation of the recording layer on the surface of a base layer (that is, an initial growth layer) has the below-described structure. The recording layer is a polycrystal formed of multiple ferromagnetic crystal grains and a nonmagnetic grain boundary part formed between the crystal grains. The crystal grains are high in Co content, and the grain boundary part is high in Cr content. If the crystallinity of the crystal grains decreases, or if adjacent crystal grains are not separated sufficiently by the grain boundary part, the saturation magnetization of the recording layer decreases, and the anisotropic magnetic field thereof also decreases. The initial growth layer of the recording layer shown in FIG. 1 is believed to be in such a state.

If the recording layer includes such an initial growth layer, a reduction in the film thickness of the recording layer causes a sharp degradation of its magnetic characteristics (saturation magnetization and anisotropic magnetic field). Even if the recording layer is not reduced in film thickness, the recording layer is prevented from having good magnetic characteristics. In such a recording layer, there occurs a problem in that the coercive force is reduced because the anisotropic magnetic field is reduced. Further, the heat-resisting fluctuation characteristic of the recording layer, that is, the thermal stability of magnetization recorded in the recording layer, is degraded.

### SUMMARY OF THE INVENTION

Accordingly, it is a general object of the present invention to provide a magnetic recording medium in which the above-described disadvantages are eliminated.

A more specific object of the present invention is to provide a magnetic recording medium that has an excellent S/N ratio and is employable with higher recording densities, and a magnetic storage unit and a magnetic disk unit including the same.

The above objects of the present invention are achieved by a magnetic recording medium including a substrate, a base layer provided on the substrate, and a recording layer provided on the base layer, wherein the recording layer includes a first magnetic layer and a second magnetic layer from a base layer side, each of the first magnetic layer and the second magnetic layer includes a ferromagnetic material composed mainly of CoCrPtB, and the first magnetic layer contains more B and less Cr than the second magnetic layer on an atomic percentage basis.

The above objects of the present invention are also achieved by a magnetic recording medium including a substrate, a base layer provided on the substrate, and a recording layer provided on the base layer, wherein the recording layer includes n magnetic layers, the n magnetic layers being first through n^{th} magnetic layers provided successively from a base layer side, each of the first through n^{th} magnetic layers includes a ferromagnetic material composed mainly of a CoCrPtB alloy, and each of the first through (n-1)^{th} magnetic layers contains more B and less Cr on an atomic percentage basis than a corresponding one of the second through n^{th} magnetic layers immediately thereabove.

According to one aspect of the present invention, the recording layer of a magnetic recording medium is formed by providing a first magnetic layer and a second magnetic layer successively from the base layer side. Each of the first magnetic layer and the second magnetic layer is formed of a ferromagnetic material composed mainly of CoCrPtB. The first magnetic layer is composed so as to contain more B and less Cr than the second magnetic layer on an atomic percentage basis. By thus setting the B content, miniaturization of the crystal grains of the first magnetic layer is promoted by the action of adding B. That is, the crystal grains are reduced in size in their cross sections parallel to the substrate surface. Further, the crystal grains of the second magnetic layer grow on their corresponding crystal grains of the first magnetic layer. Accordingly, the crystal grains of the second magnetic layer are also miniaturized. As a result, the crystal grains of both the first magnetic layer and the second magnetic layer are miniaturized, so that the medium noise of the magnetic recording medium is reduced.

Further, in the first magnetic layer, by thus setting the B content, Cr and B, which are nonmagnetic elements, are diffused in the grain boundary part separating adjacent crystal grains, so that so-called segregation of Cr and B is promoted. Accordingly, the thickness of the grain boundary part increases so as to enlarge the gap between the adjacent crystal grains. This is also inherited by the second magnetic layer. Accordingly, the crystal grains of the first magnetic layer and the second magnetic layer are formed in isolation from each other, so that the magnetic or exchange interaction between the crystal grains is reduced. The medium noise is also reduced in this aspect.

On the other hand, the first magnetic layer is set to a composition such that its Cr content is less than that of the second magnetic layer. This makes it possible to increase the Co content of the crystal grains of the first magnetic layer, thereby improving the crystallinity of the crystal grains. The crystal grains are composed mainly of CoCrPtB, of which Co atoms form the skeleton of the hcp (hexagonal close packing) structure. Accordingly, the more the Co content the better the crystallinity. Further, the crystal grains of the second magnetic layer, which inherit the excellent crystallinity of the crystal grains of the first magnetic layer, have excellent crystallinity. As a result, the anisotropic magnetic field increases to increase the coercive force. Further, the saturation magnetization also increases for the same reason. Accordingly, the magnetic recording medium has characteristics suitable for high-density recording.

Accordingly, a magnetic recording medium according to the present invention is reduced in medium noise and has an excellent S/N ratio, thus being employable with higher recording densities.

The above objects of the present invention are also achieved by a magnetic storage unit including a magnetic recording medium according to the present invention, and a recording and reproduction part including a recording element and a magnetoresistive reproduction element.

The above objects of the present invention are also achieved by a magnetic disk unit including a magnetic disk including a disk substrate, a base layer provided on the substrate, and a recording layer provided on the base layer; and a recording and reproduction part including a recording element and a magnetoresistive reproduction element, wherein the recording layer includes a first magnetic layer and a second magnetic layer from a base layer side; each of the first magnetic layer and the second magnetic layer includes a ferromagnetic material composed mainly of CoCrPtB; and the first magnetic layer contains more B and less Cr than the second magnetic layer on an atomic percentage basis.

### BRIEF DESCRIPTION OF THE DRAWINGS

Other objects, features and advantages of the present invention will become more apparent from the following detailed description when read in conjunction with the accompanying drawings, in which:

FIG. 1 is a graph showing the relationship between the magnetic characteristics and the thickness of the recording layer of a magnetic recording medium;

FIG. 2 is a cross-sectional view of a magnetic recording medium according to a first embodiment of the present invention;

FIG. 3 is a cross-sectional view of a magnetic recording medium according to a first variation of the first embodiment of the present invention;

FIG. 4 is a cross-sectional view of a magnetic recording medium according to a second variation of the first embodiment of the present invention;

FIG. 5 is a cross-sectional view of a magnetic recording medium according to a third variation of the first embodiment of the present invention;

FIG. 6A shows a TEM photograph of a second magnetic layer of an example magnetic disk according to the first embodiment of the present invention;

FIG. 6B shows a TEM photograph of a second magnetic layer of a comparative magnetic disk to be compared with the example magnetic disk;

FIG. 7 is a table showing the characteristics of the example magnetic disk and the comparative magnetic disk; and

FIG. 8 is a plan view of part of a magnetic storage unit according to a second embodiment of the present invention.

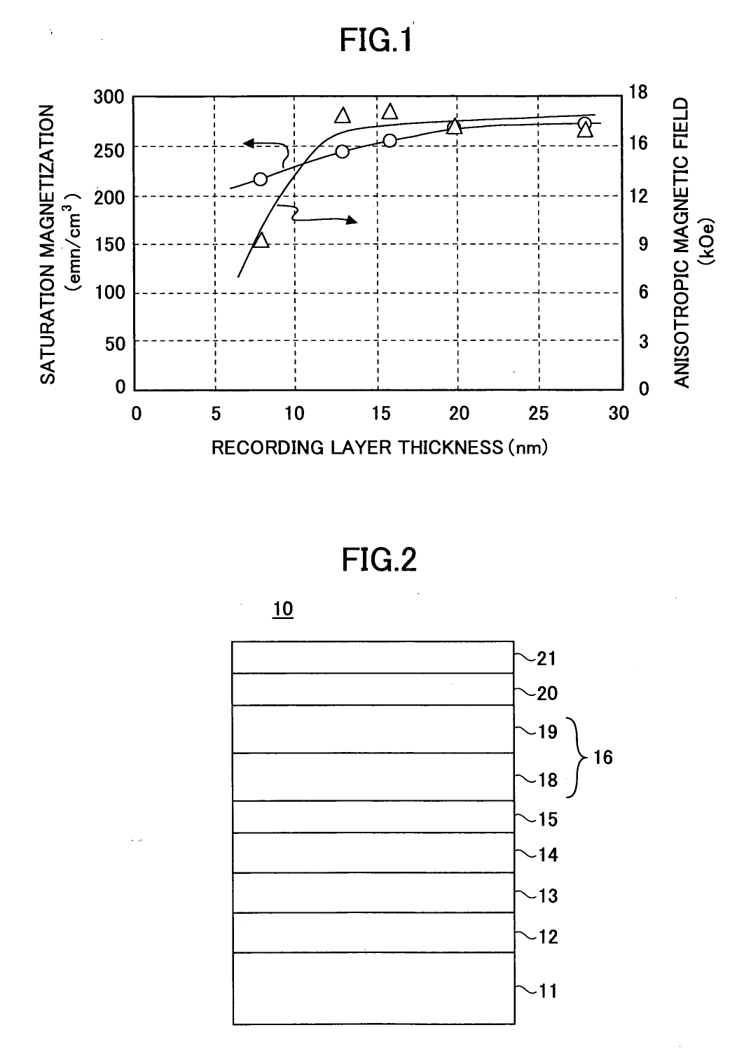

### DETAILED DESCRIPTION OF THE PREFERRED EMBODIMENTS

A description is given below, with reference to the accompanying drawings, of embodiments of the present invention.

### First Embodiment

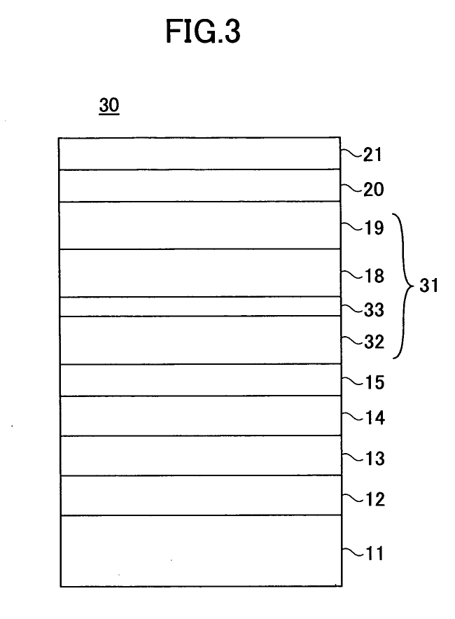

FIG. 2 is a cross-sectional view of a magnetic recording medium 10 according to a first embodiment of the present invention.

Referring to FIG. 2, the magnetic recording medium 10 includes a substrate 11, a first seed layer 12, a second seed layer 13, a base layer 14, an intermediate layer 15, a recording layer 16, a protection film 20, and a lubrication layer 21. The first seed layer 12, the second seed layer 13, the base layer 14, the intermediate layer 15, the recording layer 16, the protection film 20, and the lubrication layer 21 are formed successively on the substrate 11. The recording layer 16 has a two-layer structure of a first magnetic layer 14 and a second magnetic layer 19 provided successively from the base layer 14 side.

There is no particular limitation to the material of the substrate 11. For instance, a glass substrate, a NiP-plated aluminum alloy substrate, a silicon substrate, a plastic substrate, a ceramic substrate, and a carbon substrate may be employed as the substrate 11.

A so-called texture (not graphically illustrated) formed of multiple grooves extending along a predetermined direction may be provided on the surface of the substrate 11. Preferably, the predetermined direction is substantially parallel to the recording direction of the magnetic recording medium 10. For instance, if the magnetic recording medium 10 is shaped like a disk, the predetermined direction is a circumferential direction thereof. This makes it possible to orient the c axis of a CoCrPtB alloy film forming the recording layer 16 in the circumferential direction. Since the c axis of the CoCrPtB alloy film is a magnetocrystalline easy axis, the coercive force of the recording layer 16 increases. This provides suitable magnetic characteristics as the magnetic recording medium 10 of high recording density. Such a texture is not limited to the surface of the substrate 11. Alternatively, such a texture may be provided to the surface of the below-described first seed layer 12 or second seed layer 13.

The first seed layer 12 is formed of a nonmagnetic amorphous metal material. The metal materials suitable for the first seed layer 12 include CoW, CrTi, NiP, CoCrZr, and metals including these metals as their main components. Preferably, the first seed layer 12 is set to be 5 nm to 30 nm in thickness. The surface of the first seed layer 12 is amorphous and crystallographically uniform. Accordingly, the first seed layer 12 is prevented from exerting the effect of crystallographic anisotropy on the second seed layer 13 formed thereon. This makes it easy for the second seed layer 13 to form its own crystal structure. Accordingly, the crystallinity and the crystal orientation of the second seed layer 13 improve. This effect improves the crystallinity and the crystal orientation of the recording layer 16 through the base layer 14 on the second seed layer 13. If the second seed layer 13 is not provided, the first seed layer 12 produces the same effect on the base layer 14.

The second seed layer 13 is formed of a nonmagnetic crystalline metal material having the B2 structure. The metal materials suitable for the second seed layer 13 include, for instance, AlRu and NiAl. Preferably, the second seed layer 13 is set to be 1 nm to 100 nm in thickness. The B2 structure is a CsCl (cesium chloride)-type metal ordered phase based on the bcc (body-centered cubic) structure. Further, since the base layer 14 formed on the second seed layer 13 has the bcc structure, the second seed layer 13 and the base layer 14 approximate each other in crystal structure. Accordingly, the crystal orientation of the base layer 14 improves.

The second seed layer 13 is a polycrystal formed of multiple crystal grains. The second seed layer 13 may be configured by stacking thin films (for instance, 5 nm in thickness) formed of the above-described material in terms of controlling the size increase of the crystal grains in their cross sections parallel to the substrate surface. This makes it possible to control the enlargement of the crystal grains while maintaining the crystallinity of the second seed layer 13 itself. As a result, it is also possible to control the enlargement of the crystal grains of each of the first magnetic layer 18 and the second magnetic layer 19 through the base layer 14.

Preferably, the magnetic recording medium 10 includes both the first seed layer 12 and the second seed layer 13. However, it is also possible to omit one or both of the first seed layer 12 and the second seed layer 13.

The base layer 14 is formed of Cr or a Cr alloy having the bcc crystal structure. The Cr alloy suitable for the base layer 14 is a Cr—X₃ alloy, where X₃ is a metal selected from W, V, Mo, Mn, and their alloys. Preferably, the base layer 14 is set to be 3 nm to 10 nm in thickness. By adding the metal X₃ to Cr, it is possible to control the lattice constant of the base layer 14 and improve its lattice matching characteristic with the intermediate layer. As a result, it is possible to increase the crystallinity of the intermediate layer 15. Further, the crystal orientation of the intermediate layer 15, that is, the c axis of the crystal axes of the intermediate layer 15, is oriented in a direction parallel to the substrate surface (hereinafter referred to as “in-plane direction”). This crystal orientation is inherited by the first magnetic layer 18 and the second magnetic layer 19, and orients the c-axis of each of the first magnetic layer 18 and the second magnetic layer 19 in the in-plane direction. If the intermediate layer 15 is not provided, the base layer 14 produces the same effect on the first magnetic layer 18.

Further, the base layer 14 may be configured by stacking thin films (for instance, 2 nm in thickness) formed of the above-described material. This makes it possible to control the enlargement of the crystal grains of the base layer 14 while maintaining its crystallinity. As a result, it is possible to control the enlargement of the crystal grains of the first magnetic layer 18 and the second magnetic layer 19.

The intermediate layer 15 is formed of a Co—X₂ alloy having the hcp (hexagonal close packing) structure, where X₂ is selected from Cr, Ta, Mo, Mn, Re, Ru, Hf, and their alloys. Preferably, the intermediate layer 15 is set to 0.5 nm to 3.0 nm in thickness. The intermediate layer 15 grows epitaxially on the surface of the base layer 14 so as to form the hcp structure. The first magnetic layer 18 is a CoCrPtB film and has the hcp structure. Accordingly, as a result of providing the intermediate layer 15, the crystal coherency of the intermediate layer 15 and the first magnetic layer 18 becomes excellent. As a result, in the area of the first magnetic layer 18 near the interface with the intermediate layer 15 (or a so-called initial growth layer), a desirable structure where crystal grains are separated by a grain boundary part so as to improve the crystallinity of the crystal grains is formed. In consequence, the medium noise of the recording layer 16 is reduced.

Further, the c-axis of the intermediate layer 15 is oriented in the in-plane direction. This promotes orientation of the c-axis of the first magnetic layer 18 in the in-plane direction. As a result, the coercive force of the recording layer 16 in the in-plane direction increases so that the recording layer 16 has a magnetic characteristic suitable for high-density recording. Like the base layer 14, the intermediate layer 15 may include multiple thin films formed of the above-described material. It is preferable, but is not necessary, to provide the intermediate layer 15.

Each of the first magnetic layer 18 and the second magnetic layer 19 is formed of a ferromagnetic material whose main component is CoCrPtB. The ferromagnetic material suitable for the first magnetic layer 18 and the second magnetic layer 19 is CoCrPtB or a CoCrPtB-M alloy, where the additional component M is formed of at least one of Cu, Ag, Nb, Ru, Ni, V, Ta, Au, Fe, Mn, Ir, Si, and Pb.

The first magnetic layer 18 is composed so as to contain more B and less Cr than the second magnetic layer 19 on an atomic percentage basis. By thus setting the B content, the size of the crystal grains of the first magnetic layer 18 in their cross sections parallel to the substrate surface is reduced, so that miniaturization of the crystal grains is promoted. Further, since each crystal grain of the second magnetic layer 19 grows on a corresponding one of the crystal grains of the first magnetic layer 18, the crystal grains of the second magnetic layer 19 are also miniaturized. Thus, the crystal grains of the first magnetic layer 18 and the second magnetic layer 19 are miniaturized, so that the medium noise is reduced.

Further, in the first magnetic layer 18, by thus setting the B content, Cr and B, which are nonmagnetic elements, are diffused in the grain boundary part separating adjacent crystal grains, so that so-called segregation of Cr and B is promoted. Accordingly, the thickness of the grain boundary part increases so as to enlarge the gap between the adjacent crystal grains. The crystal grains are formed in isolation from each other so that the magnetic or exchange interaction between the crystal grains is reduced. The medium noise is also reduced in this aspect. Accordingly, the medium noise is further reduced.

On the other hand, as described above, the first magnetic layer 18 is set to a composition such that its Cr content is less than that of the second magnetic layer 19. This makes it possible to increase the Co content of the crystal grains of the first magnetic layer 18, thereby improving the crystallinity of the crystal grains. The crystal grains are composed mainly of CoCrPtB, of which Co atoms form the skeleton of the hcp structure. Accordingly, the more the Co content the better the crystallinity is kept.

Further, the crystal grains of the second magnetic layer 19, which inherit the excellent crystallinity of the crystal grains of the first magnetic layer 18, have excellent crystallinity. As a result, the anisotropic magnetic field increases to increase the coercive force. Further, the saturation magnetization also increases. Accordingly, the magnetic recording medium 10 has characteristics suitable for high-density recording.

In order to cause good crystal growth of the second magnetic layer 19 on the surface of the first magnetic layer 18, it is preferable that the first magnetic layer 18 be thicker than the second magnetic layer 19. The thickness of the entire recording layer 16 formed of the first magnetic layer 18 and the second magnetic layer 19 is limited to a predetermined value by resolution and the overwrite characteristics in the electromagnetic conversion characteristics of the magnetic recording medium 10. Meanwhile, as the first magnetic layer 18 becomes thicker, its surface condition becomes better. Specifically, the degree of separation between and the crystallinity of the crystal grains of the surface of the first magnetic layer 18 become better. This results in good crystallinity and crystal orientation of the second magnetic layer 19, thus increasing the coercive force.

In terms of reducing the medium noise, it is preferable that the second magnetic layer 19 contain more of the additional component M than the first magnetic layer 18 on an atomic percentage basis.

The protection film 20, which is selected from well known protection film materials, is formed of, for instance, diamond-like carbon, carbon nitride, or amorphous carbon. The protection film 20 is set to be 0.5 nm to 10 nm (preferably 0.5 nm to 5 nm) in thickness.

The lubrication layer 21 is not limited in particular. For instance, an organic liquid lubricant formed of perfluoropolyether as a main chain and a hydroxy group or a phenyl group as an end group may be used. A suitable lubricant is selected in accordance with the material of the protection film 20.

Next, a description is given, with reference to FIG. 2, of a method of manufacturing the magnetic recording medium 10 according to the first embodiment. First, in the case of forming a texture on the surface of the substrate 11, texture processing is performed before placing the substrate 11 on a sputtering device. The texture processing is performed using a texture forming device. Specifically, a pad is pressed against the surface of the substrate 11, and polishing traces are formed on the surface of the substrate 11 by moving the substrate 11 and the pad relative to each other while supplying slurry including abrasive on the surface of the substrate 11. In the case of forming a texture on the surface of the first seed layer 12 or the second seed layer 13, the texture is formed in the same manner.

Next, after cleaning the surface of the substrate 11, the substrate 11 is placed on a sputtering device such as a DC magnetron sputtering device, and the substrate 11 is heated at, for instance, approximately 180° C. It is preferable to evacuate the chamber of the DC magnetron sputtering device in advance until the degree of vacuum becomes lower than or equal to 1×10⁻⁵ Pa, before supplying an inert gas such as Ar gas or a process gas into the chamber.

Next, an inert gas such as Ar gas is supplied into the chamber, and the first seed layer 12 through the second magnetic layer 19 are formed using sputtering targets of their respective materials. The substrate 11 may be further heated during formation of the first seed layer 12 through the second magnetic layer 19.

Next, the protection film 20 is formed on the second magnetic layer 19 using sputtering, CVD, or FCA (Filtered Cathodic Arc). Further, the lubrication layer 21 is formed on the protection film 20. Specifically, the lubrication layer 21 is formed by applying a dilute lubricant solution on the protection film 20 by dipping or spin coating. Thereby, the magnetic recording medium 10 according to the first embodiment is formed. Magnetic recording media according to the below-described variations of this embodiment are manufactured by substantially the same method as the magnetic recording medium 10 of this embodiment.

As described above, the magnetic recording medium 10 according to this embodiment is reduced in medium noise and has an excellent S/N ratio, thus being employable with higher recording densities. Further, since the crystal grains of the first magnetic layer 18 and the second magnetic layer 19 have excellent crystallinity, the anisotropic magnetic field is increased. As a result, the coercive force in the in-plane direction increases. In this aspect, the magnetic recording medium 10 can also have high recording density.

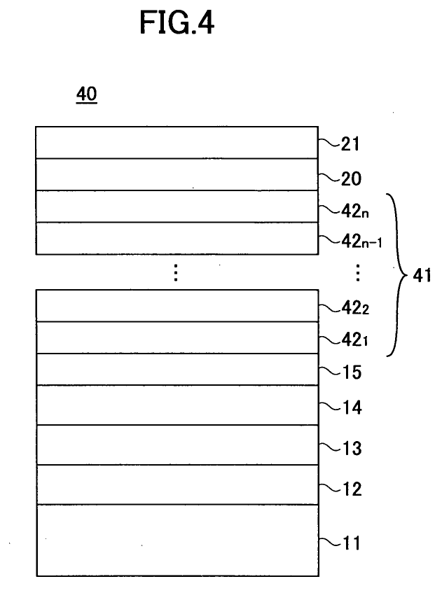

FIG. 3 is a cross-sectional view of a magnetic recording medium 30 according to a first variation of the first embodiment. In FIG. 3, the same elements as those described above are referred to by the same numerals, and a description thereof is omitted.

Referring to FIG. 3, the magnetic recording medium 30 includes the substrate 11, the first seed layer 12, the second seed layer 13, the base layer 14, the intermediate layer 15, a recording layer 31, the protection film 20, and the lubrication layer 21. The first seed layer 12, the second seed layer 13, the base layer 14, the intermediate layer 15, the recording layer 31, the protection film 20, and the lubrication layer 21 are formed successively on the substrate 11. The magnetic recording medium 30 is equal in configuration to the magnetic recording medium 10 of the first embodiment except for the recording layer 31, which is different from the recording layer 16.

The recording layer 31 includes a lower magnetic layer 32, a nonmagnetic coupling layer 33, the first magnetic layer 18, and the second magnetic layer 19, which are provided successively from the substrate 11 side. The recording layer 31 has an exchange coupling structure where the lower magnetic layer 32 and the first magnetic layer 18 are antiferromagnetically exchange-coupled through the nonmagnetic coupling layer 33. That is, the magnetization of the lower magnetic layer 32 and the magnetization of the first magnetic layer 18 are directed antiparallel to each other without application of an external magnetic field. Since the first magnetic layer 18 and the second magnetic layer 19 are ferromagnetically exchange-coupled, the lower magnetic layer 32 and the second magnetic layer 19 are antiferromagnetically exchange-coupled indirectly.

The lower magnetic layer 32 is formed of a ferromagnetic material of CoCr or a CoCr—X₁ alloy, where the additional element X₁ is at least a selected one of Pt, B, Ta, Ni, Cu, Ag, Fe, Nb, Au, Mn, Ir, Si, and Pd. The CoCr—X₁ alloy is preferable because it provides good control over the grain size of the lower magnetic layer 32. The lower magnetic layer 32 may include more than one layer. The lower magnetic layer 32 may have a multilayer configuration of multiple films formed of the above-described ferromagnetic material.

The nonmagnetic coupling layer 33 is selected from, for instance, Ru, Rh, Ir, Ru alloys, Rh alloys, and Ir alloys. Preferably, the nonmagnetic coupling layer 33 is formed of Ru or a Ru alloy having the hcp structure, which has good crystal coherency with the first magnetic layer 18. This is because the first magnetic layer 18 has the hcp structure and has a lattice constant approximating that of Ru or a Ru alloy. The Ru alloy may be the alloy of one of Co, Cr, Fe, Ni, Mn, and their alloys and Ru.

Preferably, the nonmagnetic coupling layer 33 is set to be 0.4 nm to 1.2 nm in thickness. By setting the thickness of the nonmagnetic coupling layer 33 within this range, the magnetization of the lower magnetic layer 32 and the magnetization of the first magnetic layer 18 are antiferromagnetically exchange-coupled through the nonmagnetic coupling layer 33.

The lower magnetic layer 32 and each of the first magnetic layer 18 and the second magnetic layer 19 are thus antiferromagnetically exchange-coupled. Accordingly, the total volume occupied by the exchange-coupled magnetization increases. As a result, the thermal stability of recorded magnetization increases. In high-density recording, the total volume occupied by this magnetization decreases. However, this decrease can be controlled by the lower magnetic layer 32. Accordingly, it is possible to prevent degradation of the thermal stability of recorded magnetization.

In terms of stronger exchange-coupling with the lower magnetic layer 32, it is preferable that the first magnetic layer 18 contain more Co than the second magnetic layer 19 on an atomic percentage basis.

The magnetic recording medium 30 according to the first variation produces the same effects as the magnetic recording medium 10 of the first embodiment. Further, the thermal stability of magnetization recorded in the recording layer 31 is excellent. As a result, the magnetic recording medium 30 is employable with higher recording densities. Further, setting the Co content of the first magnetic layer 18 to a value greater than that of the second magnetic layer 19 makes it possible to further strengthen the antiferromagnetic exchange coupling of the lower magnetic layer 32 and the first magnetic layer 18 and further improve the thermal stability of magnetization recorded in the recording layer 31 of the magnetic recording medium 30.

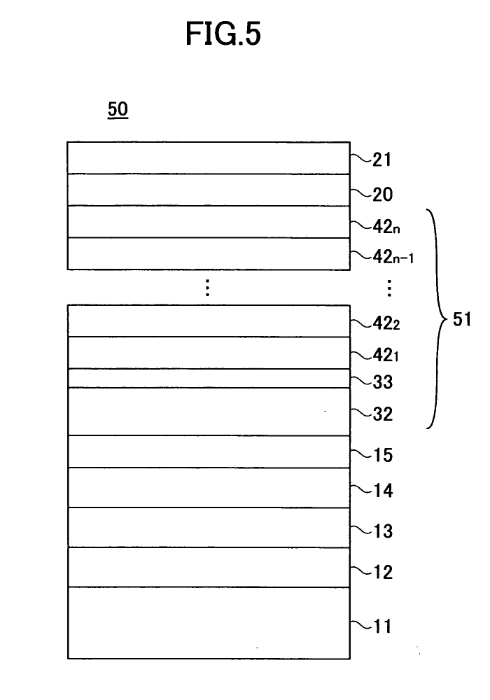

FIG. 4 is a cross-sectional view of a magnetic recording medium 40 according to a second variation of the first embodiment. In FIG. 4, the same elements as those described above are referred to by the same numerals, and a description thereof is omitted.

Referring to FIG. 4, the magnetic recording medium 40 includes the substrate 11, the first seed layer 12, the second seed layer 13, the base layer 14, the intermediate layer 15, a recording layer 41, the protection film 20, and the lubrication layer 21. The first seed layer 12, the second seed layer 13, the base layer 14, the intermediate layer 15, the recording layer 41, the protection film 20, and the lubrication layer 21 are formed successively on the substrate 11. The magnetic recording medium 40 is equal in configuration to the magnetic recording medium 10 of the first embodiment except for the recording layer 41, which is different from the recording layer 16.

The recording layer 41 includes n magnetic layers of a first magnetic layer 42₁, a second magnetic layer 42₂, . . . , an (n-1)^{th} magnetic layer 42ₙ₋₁, and an n^{th} magnetic layer 42ₙ provided successively from the substrate 11 side, where n is an integer greater than or equal to 3. In the recording layer 41, the number of recording layers is increased from two of the recording medium 10 of the first embodiment to n.

Each of the first magnetic layer 42₁ through the n^{th} magnetic layer 42ₙ is formed of the same material as the first magnetic layer 18 and the second magnetic layer 19 of the magnetic recording medium 10 of the first embodiment illustrated in FIG. 2.

Each of the first magnetic layer 42₁ through the (n-1)^{th} magnetic layer 42ₙ₋₁ is composed so as to contain more B and less Cr than the magnetic layer thereon (immediately thereabove) on an atomic percentage basis. This promotes miniaturization of the crystal grains of the lower magnetic layer, and the grain size of the crystal grains is inherited by the upper magnetic layer, so that the crystal grains of the upper magnetic layer are also miniaturized. As a result, the crystal grains of the first magnetic layer 42₁ through the n^{th} magnetic layer 42ₙ are miniaturized, so that the medium noise is reduced.

The magnetic recording medium 40 according to the second variation produces the same effects as the magnetic recording medium 10 of the first embodiment, and further reduces medium noise. Accordingly, the magnetic recording medium 40 has an excellent S/N ratio and is employable with higher recording densities.

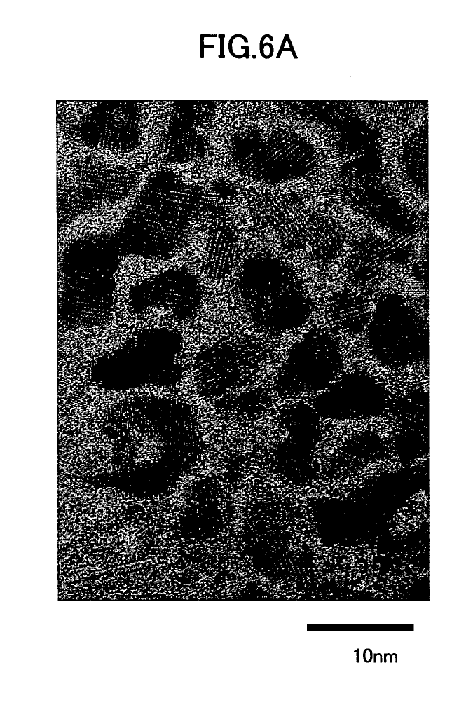

FIG. 5 is a cross-sectional view of a magnetic recording medium 50 according to a third variation of the first embodiment. In FIG. 5, the same elements as those described above are referred to by the same numerals, and a description thereof is omitted.

Referring to FIG. 5, the magnetic recording medium 50 includes the substrate 11, the first seed layer 12, the second seed layer 13, the base layer 14, the intermediate layer 15, a recording layer 51, the protection film 20, and the lubrication layer 21. The first seed layer 12, the second seed layer 13, the base layer 14, the intermediate layer 15, the recording layer 51, the protection film 20, and the lubrication layer 21 are formed successively on the substrate 11. The magnetic recording medium 50 is equal in configuration to the magnetic recording medium 10 of the first embodiment except for the recording layer 51, which is different from the recording layer 16.

The recording layer 51 includes the lower magnetic layer 32, the nonmagnetic coupling layer 33, the first magnetic layer 42₁, the second magnetic layer 42₂, . . . , the (n-1)^{th} magnetic layer 42ₙ₋₁, and the n^{th} magnetic layer 42ₙ provided successively from the substrate 11 side. That is, the recording layer 51 is a combination of the exchange coupling structure of the recording layer 31 of the magnetic recording medium 30 according to the first variation illustrated in FIG. 3 and the n magnetic layers of the recording layer 41 of the magnetic recording medium 40 according to the second variation illustrated in FIG. 4.

Accordingly, the magnetic recording medium 50 according to the third variation produces the effects of the magnetic recording medium 10 according to the first embodiment, and further reduces medium noise. Further, the thermal stability of magnetization recorded in the recording layer 51 of the magnetic recording medium 50 is excellent.

An example according to the first embodiment and a comparative example that is not according to the present invention are illustrated below.

### EXAMPLE

An example magnetic disk was equal in configuration to the magnetic recording medium 10 according to the first embodiment illustrated in FIG. 2. The specifics of configuration are as follows:

Glass substrate (65 nm in diameter);

First seed layer: Cr₅₀Ti₅₀ film (25 nm);

Second seed layer: Al₅₀Ru₅₀ film (25 nm);

Base layer: Cr₇₅Mo₂₅ film (5 nm);

Intermediate layer: Co₅₈Cr₄₂ film (1 nm); First magnetic layer: Co₆₅Cr₁₁Pt₁₁B₁₃ film (10 nm);

Second magnetic layer: Co₆₀Cr₁₈Pt₁₁B₈Cu₃ film (5 nm);

Protection film: amorphous carbon film (5 nm); and

Lubrication layer: AM3001 (1.5 nm), where the parenthesized numeric values represent thickness, and the numeric values of composition are expressed by atomic %.

The example magnetic disk was prepared as follows. First, a texture extending along a circumferential direction was formed on the surface of a glass substrate. Next, the surface of the glass substrate was cleaned, and the glass substrate was heated to 200° C. in a vacuum using a heating device.

Next, of the above-described film configuration, the Cr₅₀Ti₅₀ film through the amorphous carbon film were successively formed in an Ar gas atmosphere (at a pressure of 0.67 Pa) in their respective vacuum chambers of a DC magnetron sputtering device. Next, the lubrication layer was applied on the surface of the amorphous carbon film by dipping. The vacuum chambers of the heating device and the DC magnetron sputtering device were evacuated in advance to a high vacuum of 1×10⁻⁵ Pa or below. Thereafter, an Ar gas was supplied to the vacuum chambers so that the above-described pressure was set inside the vacuum chambers.

### Comparative Example

A magnetic disk of the comparative example (hereinafter “comparative magnetic disk”) was equal in configuration to the example magnetic disk except that a ferromagnetic material having the same composition as the second magnetic layer of the example magnetic disk was used for each of the first magnetic layer and the second magnetic layer. The comparative magnetic disk was prepared in substantially the same manner as the example magnetic disk. The first magnetic layer and the second magnetic layer of the comparative magnetic disk were formed in different vacuum chambers, and the film formation was temporarily stopped between the first magnetic layer and the second magnetic layer. The layers of the comparative magnetic disk different from those of the example magnetic disk are shown as follows:

First magnetic layer: Co₆₀Cr₁₈Pt₁₁B₈Cu₃ film (10 nm); and

Second magnetic layer: Co₆₀Cr₁₈Pt₁₁B₈Cu₃ film (5 nm).

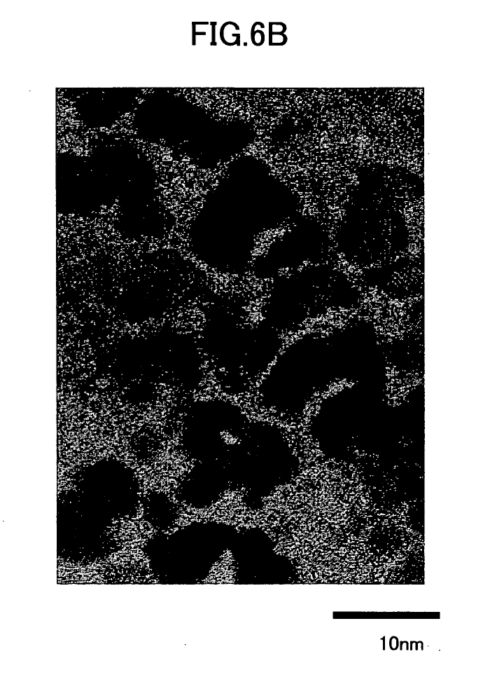

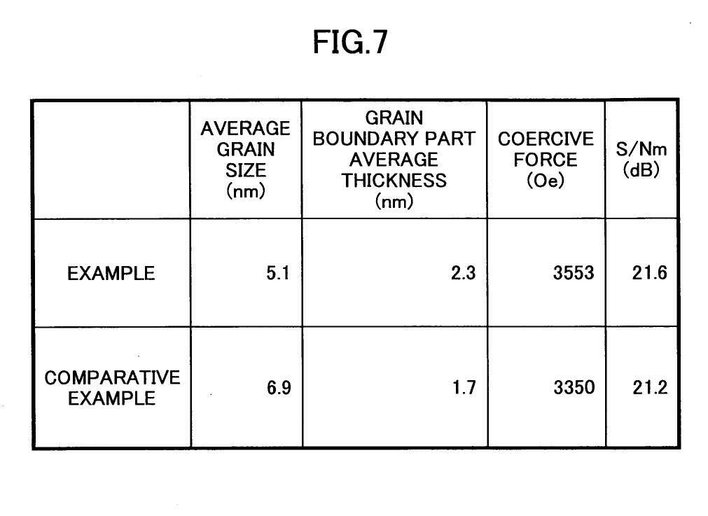

FIG. 6A shows a TEM (transmission electron microscope) photograph of the second magnetic layer of the example magnetic disk according to the present invention. FIG. 6B shows a TEM photograph of the second magnetic layer of the comparative magnetic disk. Each TEM photograph shows the surface of the second magnetic layer, in which a darker area indicates crystal grains and a lighter area surrounding the darker area indicates a grain boundary part. FIG. 7 is a table showing the characteristics of the example magnetic disk and the comparative magnetic disk. The magnetic characteristics of the magnetic disks are shown together in FIG. 7.

FIGS. 6A, 6B, and 7 show that each crystal grain is smaller in the example magnetic disk than in the comparative magnetic disk although the example magnetic disk and the comparative magnetic disk are equal in the composition of the second magnetic layer. FIG. 7 shows that the average grain size of the crystal grains of the example magnetic disk is reduced by 26% compared with that of the comparative magnetic disk. That is, FIG. 7 shows that the miniaturization of the crystal grains of the second magnetic layer is more promoted in the example magnetic disk than in the comparative magnetic disk.

The distance between adjacent crystal grains of the second magnetic layer, that is, the thickness of the grain boundary part, is greater in the example magnetic disk than in the comparative magnetic disk. FIG. 7 shows that the average thickness of the grain boundary part of the example magnetic disk is increased by 35% compared with that of the comparative magnetic disk. This shows that more Cr and B have moved to the grain boundary part and so-called segregation of Cr and B is more promoted in the example magnetic disk than in the comparative magnetic disk. It is easily inferable from this that the Co content in the crystal grain composition of the example magnetic disk is greater than that in the crystal grain composition of the comparative magnetic disk. When the Co content increases, the saturation magnetization increases so as to produce a desirable effect that the reproduction output increases.

The average grain size of the crystal grains and the average thickness of the grain boundary part were obtained as follows using a TEM photograph of the surface of the second magnetic layer (a total magnification of approximately 2,000,000 times). First, the area of crystal grains in a predetermined region was obtained using an image analyzer. In obtaining the area of the crystal grains, each crystal grain was approximated to an elliptic shape, and the area of the elliptic shape was defined as the area of the crystal grain. Next, the diameter of a complete circle equal in area to the elliptic shape was defined as the grain size of the crystal grain. Thus, the grain size was obtained with respect to approximately 100 to 200 crystal grains, and the obtained (grain size) values were averaged. As a result, the average grain size of the crystal grains was obtained.

In obtaining the average thickness of the grain boundary part, first, the total area of the grain boundary part in a predetermined region was obtained using the image analyzer. Further, the total perimeter of crystal grains in the predetermined region was obtained, letting the perimeter of the above-described complete circle be the perimeter of the crystal grain. A numeric value obtained by dividing the previously obtained total area of the grain boundary part by the total perimeter of the crystal grains was defined as the average thickness of the grain boundary part.

Meanwhile, as shown in FIG. 7, the coercive force of the example magnetic disk is increased by approximately 6% compared with that of the comparative magnetic disk. It is inferable that this is because the crystal grains of the example magnetic disk have better crystallinity than those of the comparative magnetic disk.

FIG. 7 also shows that the S/Nm of the example magnetic disk is improved by 0.4 dB compared with that of the comparative magnetic disk. This is because of miniaturization of the crystal grains and an increase in the average thickness of the grain boundary part (promotion of segregation of Cr and B) As described above, according to the example magnetic disk, the first magnetic layer contained more B and less Cr than the second magnetic layer on an atomic percentage basis. Accordingly, the crystal grains of the second magnetic layer were miniaturized, and the average thickness of the grain boundary part of the second magnetic layer increased. As a result, a magnetic disk of high coercive force and high S/N ratio was obtained.

The coercive force was measured using a vibrating sample magnetometer. The S/Nm was measured using a commercially available spin stand and a composite magnetic head having an induction-type recording element and a GMR reproduction element. The S/Nm was obtained as 10×log(Siso/Nm) (dB) from average output Siso (89 kFCI) and medium noise Nm.

### Second Embodiment

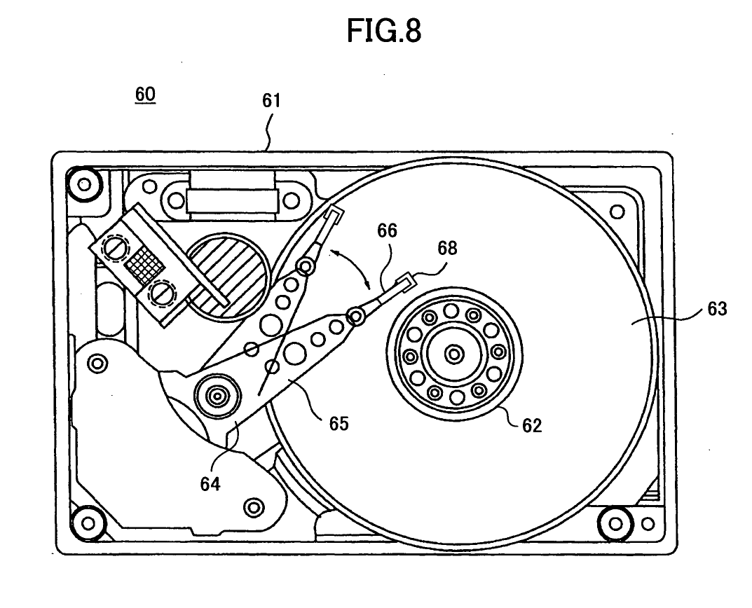

FIG. 8 is a plan view of part of a magnetic storage unit 60 according to a second embodiment of the present invention.

Referring to FIG. 8, the magnetic storage unit 60 includes a housing 61. Inside the housing 61, a hub 62 driven by a spindle (not graphically illustrated), a magnetic recording medium 63 fixed to the hub 62 and rotated, an actuator unit 64, an arm 65 and a suspension 66 attached to the actuator unit 64 and moved in the radial directions of the magnetic recording medium 63, and a magnetic head 68 supported by the suspension 66 are provided. The magnetic head 68 is formed of a composite head of a reproduction head of an MR element (magnetoresistive element), a GMR element (giant magnetoresistive element), or a TMR element (tunnel magnetoresistive element), and an induction-type recording head. The basic configuration itself of this magnetic storage unit 60 is well known, and a detailed description thereof is omitted in this specification.

The magnetic recording medium 63 is, for instance, any of the magnetic recording media 10, 30, 40, and 50 of the first embodiment and the first through third variations thereof. The magnetic recording medium 63 is reduced in medium noise and has an excellent S/N ratio. Accordingly, it is possible to employ the magnetic recording medium 63 with high recording densities.

The basic configuration of the magnetic storage unit 60 is not limited to the one illustrated in FIG. 8. The magnetic head 68 is not limited to the above-described configuration. A well know magnetic head may be employed as the magnetic head 68.

According to one aspect of the present invention, the recording layer of a magnetic recording medium is formed by providing a first magnetic layer and a second magnetic layer successively from the base layer side. Each of the first magnetic layer and the second magnetic layer is formed of a ferromagnetic material composed mainly of CoCrPtB. The first magnetic layer is composed so as to contain more B and less Cr than the second magnetic layer on an atomic percentage basis. By thus setting the B content, miniaturization of the crystal grains of the first magnetic layer is promoted by the action of adding B. That is, the crystal grains are reduced in size in their cross sections parallel to the substrate surface. Further, the crystal grains of the second magnetic layer grow on their corresponding crystal grains of the first magnetic layer. Accordingly, the crystal grains of the second magnetic layer are also miniaturized. As a result, the crystal grains of both the first magnetic layer and the second magnetic layer are miniaturized, so that the medium noise of the magnetic recording medium is reduced.

Further, in the first magnetic layer, by thus setting the B content, Cr and B, which are nonmagnetic elements, are diffused in the grain boundary part separating adjacent crystal grains, so that so-called segregation of Cr and B is promoted. Accordingly, the thickness of the grain boundary part increases so as to enlarge the gap between the adjacent crystal grains. This is also inherited by the second magnetic layer. Accordingly, the crystal grains of the first magnetic layer and the second magnetic layer are formed in isolation from each other, so that the magnetic or exchange interaction between the crystal grains is reduced. The medium noise is also reduced in this aspect.

On the other hand, the first magnetic layer is set to a composition such that its Cr content is less than that of the second magnetic layer. This makes it possible to increase the Co content of the crystal grains of the first magnetic layer, thereby improving the crystallinity of the crystal grains. The crystal grains are composed mainly of CoCrPtB, of which Co atoms form the skeleton of the hcp structure. Accordingly, the more the Co content the better the crystallinity. Further, the crystal grains of the second magnetic layer, which inherit the excellent crystallinity of the crystal grains of the first magnetic layer, have excellent crystallinity. As a result, the anisotropic magnetic field increases to increase the coercive force. Further, the saturation magnetization also increases for the same reason. Accordingly, the magnetic recording medium has characteristics suitable for high-density recording.

Accordingly, a magnetic recording medium according to the present invention is reduced in medium noise and has excellent S/N ratio, thus being employable with higher recording densities.

The present invention is not limited to the specifically disclosed embodiments, and variations and modifications may be made without departing from the scope of the present invention.

For instance, a magnetic disk is taken as an example of the magnetic recording medium 63 in the above description of the second embodiment, but the magnetic recording medium 63 may be a magnetic tape. For the magnetic tape, a tape-like substrate such as a tape-like plastic film of PET, PEN, or a polyimide is employed instead of a disk-like substrate.

The present application is based on Japanese Priority Patent Application No. 2005-073983, filed on Mar. 15, 2005, the entire contents of which are hereby incorporated by reference.

What is claimed is:

1. A magnetic recording medium, comprising:
a substrate;
a base layer provided on the substrate; and
a recording layer provided on the base layer,
wherein:
the recording layer includes a first magnetic layer and a second magnetic layer from a base layer side;
each of the first magnetic layer and the second magnetic layer includes a ferromagnetic material composed mainly of CoCrPtB; and
the first magnetic layer contains more B and less Cr than the second magnetic layer on an atomic percentage basis.

2. The magnetic recording medium as claimed in claim 1, wherein:
the recording layer further includes a lower magnetic layer and a nonmagnetic coupling layer from the base layer side below the first magnetic layer; and
the lower magnetic layer and the first magnetic layer are exchange-coupled, and magnetization of the lower magnetic layer and magnetization of the first magnetic layer are antiparallel to each other without application of an external magnetic field.

3. The magnetic recording medium as claimed in claim 2, wherein the lower magnetic layer comprises one of CoCr and a CoCr—X₁ alloy, the X₁ including at least one selected from a group of Pt, B, Ta, Ni, Cu, Ag, Fe, Nb, Au, Mn, Ir, Si, and Pd.

4. The magnetic recording medium as claimed in claim 1, wherein a Co content of the first magnetic layer is greater than or substantially equal to that of the second magnetic layer on the atomic percentage basis.

5. The magnetic recording medium as claimed in claim 1, wherein each of the first magnetic layer and the second magnetic layer comprises a CoCrPtB-M alloy including the additional component M, the additional component M including at least one selected from a group of Cu, Ag, Nb, Ru, Ni, V, Ta, Au, Fe, Mn, Ir, Si, and Pd.

6. The magnetic recording medium as claimed in claim 5, wherein an M content of the second magnetic layer is greater than that of the first magnetic layer on the atomic percentage basis.

7. The magnetic recording medium as claimed in claim 1, wherein the first magnetic layer is thicker than the second magnetic layer.

8. The magnetic recording medium as claimed in claim 1, wherein the base layer comprises one of Cr and a Cr alloy having a bcc crystal structure.

9. The magnetic recording medium as claimed in claim 8, wherein the Cr alloy comprises a Cr—X₃ alloy, the X₃ being one selected from W, V, Mo, Mn, and alloys thereof.

10. The magnetic recording medium as claimed in claim 1, further comprising:
an intermediate layer between the base layer and the recording layer, the intermediate layer including a Co—X₂ alloy having an hcp structure, the X₂ including at least one selected from a group of Cr, Ta, Mo, Mn, Re, Ru, and Hf.

11. The magnetic recording medium as claimed in claim 1, further comprising:
a crystalline seed layer between the substrate and the base layer, the crystalline seed layer having a B2 structure.

12. The magnetic recording medium as claimed in claim 11, further comprising:
an amorphous seed layer between the substrate and the base layer, the amorphous seed layer comprising one selected from a group of CoW, CrTi, NiP, CoCrZr, and metals composed mainly thereof.

13. The magnetic recording medium as claimed in claim 12, wherein the amorphous seed layer and the crystalline seed layer are provided in order described from a substrate side between the substrate and the base layer.

14. The magnetic recording medium as claimed in claim 12, wherein:
the magnetic recording medium has a disk shape; and
unevenness extending along a circumferential direction of the magnetic recording medium is formed on a surface of one of the substrate, the crystalline seed layer, and the amorphous seed layer.

15. A magnetic recording medium, comprising:
a substrate;
a base layer provided on the substrate; and
a recording layer provided on the base layer,
wherein:
the recording layer includes n magnetic layers, the n magnetic layers being first through n^{th} magnetic layers provided successively from a base layer side;
each of the first through n^{th} magnetic layers includes a ferromagnetic material composed mainly of a CoCrPtB alloy; and
each of the first through (n-1)^{th} magnetic layers contains more B and less Cr on an atomic percentage basis than a corresponding one of the second through n^{th} magnetic layers immediately thereabove.

16. The magnetic recording medium as claimed in claim 15, wherein:
the recording layer further includes a lower magnetic layer and a nonmagnetic coupling layer from the base layer side below the first magnetic layer; and
the lower magnetic layer and the first magnetic layer are exchange-coupled, and magnetization of the lower magnetic layer and magnetization of the first magnetic layer are antiparallel to each other without application of an external magnetic field.

17. A magnetic storage unit, comprising:
a magnetic recording medium as set forth in claim 1; and
a recording and reproduction part including a recording element and a magnetoresistive reproduction element.

18. A magnetic storage unit, comprising:
a magnetic recording medium as set forth in claim 15; and
a recording and reproduction part including a recording element and a magnetoresistive reproduction element.

19. A magnetic disk unit, comprising:
a magnetic disk including a disk substrate, a base layer provided on the substrate, and a recording layer provided on the base layer; and
a recording and reproduction part including a recording element and a magnetoresistive reproduction element,
wherein:
the recording layer includes a first magnetic layer and a second magnetic layer from a base layer side;
each of the first magnetic layer and the second magnetic layer includes a ferromagnetic material composed mainly of CoCrPtB; and
the first magnetic layer contains more B and less Cr than the second magnetic layer on an atomic percentage basis.
